(19) United States
(12) Patent Application Publication
(10) Pub. No.: US 2024/0425641 A1
(43) Pub. Date: Dec. 26, 2024

(54) EPOXY RESINS

(71) Applicant: SPOLEK PRO CHEMICKOU A HUTNI VYROBU, AKCIOVA SPOLECNOST, Usti nad Labem (CZ)

(72) Inventors: JAN HYRSL, Pardubice (CZ); Tomas LOUBAL, Usti nad Labem (CZ)

(73) Assignee: SPOLEK PRO CHEMICKOU A HUTNI VYROBU, AKCIOVA SPOLECNOST, Usti nad Labem (CZ)

(21) Appl. No.: 18/707,543

(22) PCT Filed: Nov. 3, 2022
(86) PCT No.: PCT/CZ2022/000044

§ 371 Date: May 3, 2024

(30) Foreign Application Priority Data
Nov. 4, 2021 (CZ) PC 2021-507

(51) Int. Cl. C08G 59/24; C08G 59/42; C08G 59/68

(52) U.S. Cl. CPC C08G 59/245; C08G 59/4276; C08G 59/688

(57) ABSTRACT

The invention relates to a high molecular weight epoxy resin composition. prepared from a low molecular weight BPA-based epoxy resin with an epoxy equivalent of 172-500 g/mol with: (a) oligomers and/or monomers and/or polymers of dicyclopen-tanediene diphenols and/or (b) bisphenol F or S or Z or C or polyalkyl BPF, alkyl biphenol. polyalkyl biphenol, or polyalkyl BPA, and/or (c) mixtures of phenolic substances (a) and (b), and/or (d) aliphatic, cycloaliphatic and aromatic polyacids or anhydrides thereof, and/or (c) aliphatic and/or cycloaliphatic and/or aromatic polyalcohols or polyphenols: and/or (f) mixtures of monomers according to (a), (d) and (c), wherein the content of free BPA in the final high molecular weight epoxy resin is below 2 ppm. preferably below 1 ppm. A method for producing the epoxy resins is also disclosed.

### FIELD OF THE INVENTION:

The present invention relates to a process for preparation of epoxy resins for use in paints, composites and adhesives with a content of free Bisphenol A (BPA) less than 2 ppm, preferably less than 1 ppm. Preferably, a content of free Bisphenol A (BPA) is less than 1 ppm after crosslinking with hardeners.

Further, a composition of cured high molecular weight epoxy resin having the free BPA content of the cured high molecular weight epoxy resin is below 1 ppm is also disclosed.

### BACKGROUND ART:

There is great pressure to eliminate the use of substances which are suspected of affecting the human hormonal system, so-called endocrine disruptors, especially for containers used for beverages such as fruit juices, carbonates drinks and beer and foodstuff.

BPA is still one of the monomers used for the production of epoxy resins and downstream production of protective coatings for these containers. Currently, BPA is included in the list of substances of very high concern (SVHC). Its TDI limit value (=tolerable daily intake) was established in January 2015 by EFSA (=European Food Safety Authority) at a threshold of 4 micrograms per kilogram of body weight per day.

Companies that have been successfully using BPA-based epoxy resins for the internal protection of cans for food and beverages for over 70 years, now face the challenge of addressing stricter requirements not only to meet the necessary limits for potential BPA migration, but also to meet consumers' legitimate concerns and rights on health protection and also environment protection.

Until now, the epoxy resins used for coating metal containers and pipes, composite pipes for drinking water, for packaging and storing of food and beverages, have served the purpose of protecting the food products from corrosion products arising from the contact of often very aggressive foods, both in terms of organic acids in juices and basic amino acids attacks on the glass and metals of the containers. Additionally the coating serves also has to protect the food products from any materials from the container itself, such as organic substances or metallic materials from the components used to manufacture the container. Primers directly at the container surface are used to provide further protection as well as ensure secure even adhesion of the coating to the container. Such primers are designed not to delaminate during processing of the container with coatings.

The corrosion products of degraded container thus very often contaminate food and beverages with heavy metals in the form of organic salts and complexes, which on consumption subsequently pass through the digestive tract and easily accumulate in the human adipose tissue.

In the recent publication, Beverages 2019.5, 3; doi: 10.3390/beverages 5010003 (MDPI Journal), it has been clearly documented that while keeping low concentrations of free BPA after synthesis and maintaining the glass transition temperature (Tg), the migration of unreacted BPA from the epoxy resin is below current acceptable limits. However, the requirement is to maintain a high Tg of the system after curing with a sufficient network polymer density and thus reduce the diffusion from the coating into the food and vice versa from the food to the metal as a source of corrosion products.

It is noted that these tests in the publication are even more damaging because up to 20% ethanol is used and an elevated temperature of 40 and 60° C. Similarly, when testing the migration of BPA in the epoxy inner protective coatings/varnishes in cans with foodstuff for children/0.1 to 13 ppb of extracted BPA was still found. Thus, it is clear that the use of a new approach to the synthesis of high molecular weight epoxy resins with even greater minimized or better still eliminated content of unreacted BPA is desired to further reduce or eliminate BPA migration into the food and beverages.

Therefore, efforts have further intensified to replace two-component high molecular weight epoxy resins based on BPA with polyester two-component resins, polyurethanes, polyamides, and thermoplastics in general, and other polymeric coatings.

For example:

U.S. Pat. No. 7,682,674 discloses coating composition based on PVC and acrylic resins,

US2003/0170396 discloses composition based on epoxynovolac resins,

WO2010/100122 describes composition based on epoxidized vegetable oil,

WO2012/091701 discloses epoxidized glycols with hydrogenated BPA,

U.S. Pat. No. 9,139,690 discloses compositions based on epoxidized cycloaliphatic diols, and

U.S. Pat. No. 9,150,685 discloses diglycidylethers of a 2-phenyl-1,3-propandiol in the mixture with BADGE (=Bisphenol A diglycidyl ether) or BFDGE (=Bisphenol F diglycidyl ether) or their hydrogenated variants. However, corrosion has always remained a problem.

In WO2021/024033, Bisphenol A or F is completely replaced by oligomers of dicyclopentadiene diphenols (DCPD). However, all the BPA replacement options offered so far fail in chemical and temperature resistance and thus do not meet the required properties of the replaced BPA-based epoxy resins, which unfortunately may contain up to thousands of ppm of unreacted BPA.

Existing processes for the preparation of safe epoxy resins are therefore based on the exclusion of the use of standard BPA/BPF epoxy resins and instead use cycloaliphatic and aliphatic glycidyl ethers or glycidyl esters, or combinations thereof and adducts with polyphenols or adducts of phenols and polyphenols with mono, di or poly cyclopentadienes and their epoxidized derivatives, alkylated or arylated bisphenols or their epoxidized derivatives, furthermore, for example, epoxidized sugars and oils and the like.

However, as described above, these materials have disadvantageous and/or problematic final properties for the most applications, especially regarding the glass transition temperature after curing, poorer chemical and corrosion resistance and also poorer strength characteristics.

Due to the cycloaliphatic or aliphatic hydroxyl, glycidyl or glycidyl ester reactive group, the preparation of high molecular weight adducts of these resins is also more difficult and problematic, requiring often use of increased amounts of phase transfer catalysts, and imparting significant negative influence on properties of the final applications, mainly in terms of softening point for binders for powder coatings, and in general also reactivity, pot life, time to reach handling strengths of coatings, composites and adhesives, chemical resistance, temperature resistance and associated creep durability.

In addition, these products are often offered as an alternative to the originally used high molecular weight BPA/BPF based epoxy resins for surface treatment for containers to be in contact with drinking water and foodstuff. Tests on these alternatives for toxicity and endocrine disruptivity are often not yet available for many declared materials.

### DESCRIPTION OF THE INVENTION:

The disadvantages of prior art replacement of BPA-based epoxy resins only with BPA-free resins and polymers mentioned above are eliminated by the process of the present invention, for the preparation of chemically and temperature resistant epoxy resins and systems with hardeners of various types, for the treatment of internal surfaces of metal containers, pipes and surfaces for drinking water and foodstuff and possibly other protective coatings [e.g. in the medical area, e.g. syringe barrel coatings], with environmental protection against free BPA.

A subject matter of the invention is a high molecular weight epoxy resin composition, prepared from a low molecular weight BPA-based epoxy resin with an epoxy equivalent of 172-500 g/mol with:
(a) oligomers and/or monomers and/or polymers of dicyclopentanediene diphenols and/or
(b) bisphenol F or S or Z or C or polyalkyl BPF, alkyl biphenol, polyalkyl biphenol, or polyalkyl BPA, and/or
(c) mixtures of phenolic substances (a) and (b), and/or
(d) aliphatic, cycloaliphatic and aromatic polyacids or their anhydrides, and/or
(e) aliphatic and/or cycloaliphatic and/or aromatic polyalcohols or polyphenols, and/or
(f) mixtures of monomers according to (a), (d) and (e),
   wherein the content of free BPA in the final high molecular weight epoxy resin is below 2 ppm, preferably below 1 ppm.

A method for producing the epoxy resins having the free BPA content of the cured high molecular weight epoxy resin is below 1 ppm is also disclosed.

These formulations and resulting coatings must not only reduce or prevent the migration of BPA into foodstuff and the environment, but must also, for example,
form a continuous [homogeneous, nonporous, pin-holes, fish eyes free] coating film on surfaces in contact with drinking water and foodstuff,
have extremely good adhesion to various surfaces used in packaging and transport of drinking water and foodstuff,
and avoid coating delamination in the presence of the content in the packaging and
stable, so that there is no formation of fragments.
additionally, there also must be no sensory changes in the stored food and beverages, medical products and other applications
and, user conditions must be met.

In the embodiment of the present invention, we enclose low molecular weight basic BPA epoxy resins, i.e. an epoxy index of 0.2 to 0.58 epoxy equivalents per 100 g of resin or epoxy equivalent weight EEW from 172 to 500 g/mol reacted with DCPD diphenolic oligomers, tetramethyl bisphenol F, optionally also terephthalic acid, isophthalic acid, cyclohexane dicarboxylic acid, bisphenol Z, bisphenol F, 4,4′-biphenol, dimethyl resorcinol and mixtures thereof, having required results at applications.

As seen structure in the below, for example, a resin reacted using, for example dicyclopentadiene diphenolic oligomers is synergistically utilized by preferred combinations with compounds or oligomers with aromatic and/or aliphatic structures with preferably high hydrophobicity and hydrolyse stability. In addition, phenolic groups provide a high degree of monomer conversion in resin synthesis and during crosslinking, where preferably a high functionality and branching are preferably used when the polymer network with hardener usage is formed, while, also maintaining advantageous application properties such as solubility in methyl ethyl ketone for spray application, fast drying and adhesion to substrates, advantageous drying at elevated temperatures for excellent curing to provide required glass transition temperature and chemical and thermal durability.

The process of the present invention is to prepare modified low molecular weight BPA-based epoxy resin with unreacted BPA content below 5 ppm by reaction with dicyclopentadiene polyphenolic dimers and/or oligomers of the structure below,

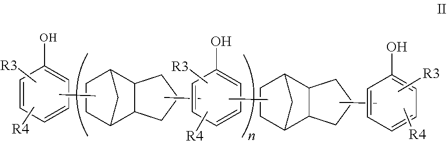

or, optionally using other monomers such as polycarboxylic acids and their anhydrides, alkylated bisphenols such as tetramethyl bisphenol F, novolacs, where the final reaction product contains free BPA after curing with hardeners well below the permitted and often also detectable limit 1 ppm, and thus meeting previously known safety, toxicological, environmental and technical requirements.

In particular, it is possible to meet all the basic application requirements for the resulting materials, both for powder coatings, solution coatings and composites in terms of their desired application, when the amount of unreacted BPA after curing is below 1 ppm, which is close to natural background and allows meet all currently required standards for food and water extracts.

Thus, the embodiment of the present invention is to provide a formulation that substantially reduces free BPA content in uncured resin without hardener and/or other additives to a level that fully meets all current hygienic and environmental limits, for example in the case of formula (1) using DCPD diphenol oligomers:

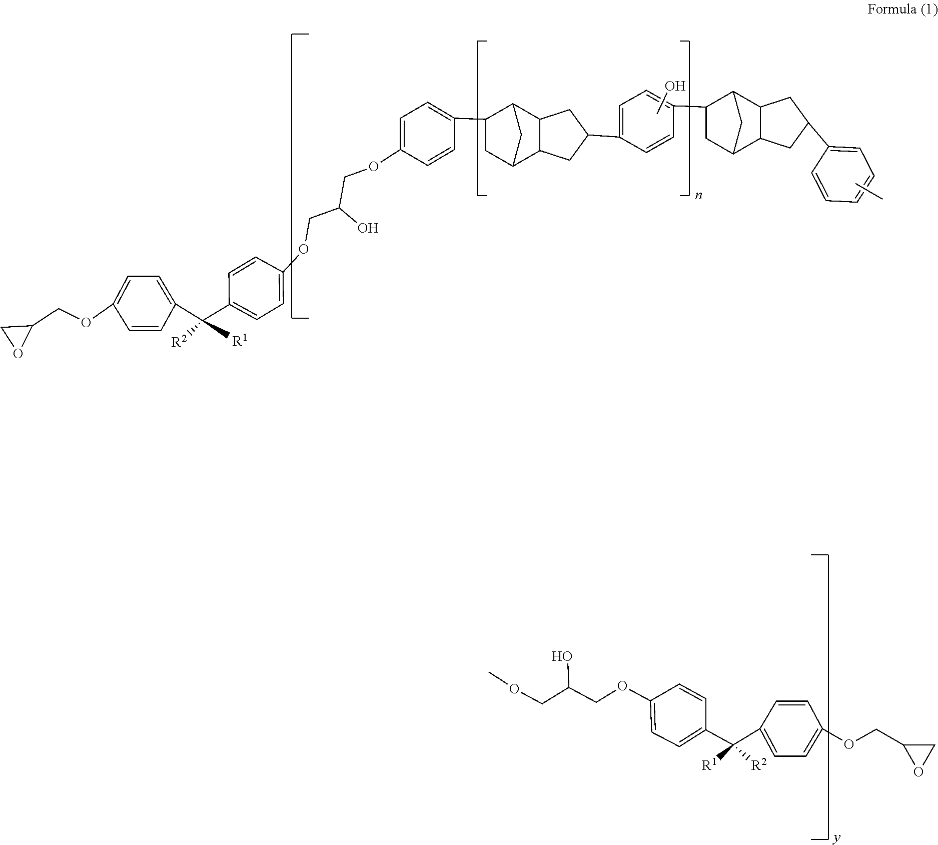

wherein R¹and/or R² are independently —CH₃, —H, ═C₆H₁₀, —R.

Preferably, a molecular weight of from 500 to 2000 Daltons, preferably from 1000 to 6000 Daltons is achieved.

In another embodiment of the present invention, as shown in formula (2) where alkaline hydrolysis is not considered, the modification of BADGE is performed by using organic polyacids such as isophthalic acid, phthalic acid or its anhydride, terephthalic acid, adipic acid or its anhydride, succinic acid or its anhydride, maleic acid or its anhydride, fumaric acid, cyclohexane dicarboxylic acid, methyl tetrahydrophthalic acid, methyl hexahydrophthalic acid, hexahydrophthalic acid, tetrahydrophthalic acid and the like.

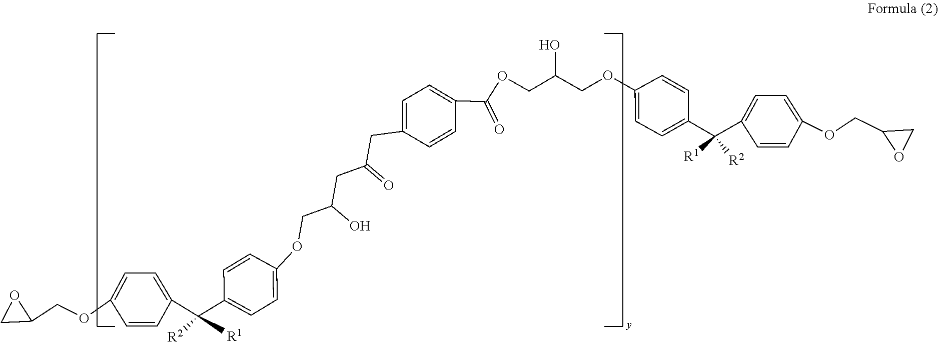

Advantageously, another formula can also be considered, where we combine the formulations described by formula (1) and formula (2) in order to achieve the required optimal performance properties by mutual combination of monomers with BPA type low molecular weight epoxy resin.

The advantage of the above solution is to allow the use of existing technological equipment and processes for the preparation of medium and high molecular weight BPA types of epoxy resins in the temperature range from 50 to 250° C. and the usual standard amount of catalysts based on onium salts, such as ammonium, phosphonium salts and other commonly used catalysts for above mentioned reactions in the range from 0.001 to 5% by weight and standard molar ratios of the reactants given by the reactivity according to the catalysts used and the softening point of the resulting resin, using either a flake strips or a final transfer of the resin in the solution using desired reactive or nonreactive solvent or solvent mixture, or an aqueous dispersion of the desired dry matter and viscosity. Preferred onium salts catalysts are selected from ethyltriphenylphosponium bromide, ethyltriphenylphosponium chloride, triphenyl phosphine, benzyltributylammonium chloride, benzyltriethylammonium chloride, benzyltrimethylammonium chloride, tetrabutylammonium bromide, tetramethylammonium chloride, tetramethylammonium bromide, tetrabutylammonium hydrogen sulfite, trioctylmethylammonium chloride, benzyltriethyl ammonium bromide, tetraethyl ammonium chloride, trimethylamine, halogenated phosphonium salts and others.

The curing process of resins prepared according to present invention is identical to the procedures used for standard BPA resins, using reactive sites such as epoxy groups, hydroxyl groups, or other introduced groups of for instance the amine or amide group type according to final purpose of the application for paints, composites, adhesives and the like. This curing process additionally decreases level of unreacted BPA in whole systems significantly due to following reactions with epoxy groups or creation salts with amines, amides or hydrogen bonds with polar groups in cured material.

In another embodiment of the present invention, a curable composition of high molecular weight epoxy resin is prepared. Said curable composition of high molecular weight epoxy resin comprises high molecular weight epoxy resin in amount of 10 to 97% by weight and a hardener.

Hardeners used to prepare a curable high molecular weight epoxy resin composition according to present invention are selected from polyetheramines, aliphatic, cycloaliphatic, heterocyclic and aromatic polyamines, and/or their adducts with cycloaliphatic and aliphatic and aromatic epoxides, urea derivatives and dicyandiamide.

Further, hardeners used to prepare a curable high molecular weight epoxy resin composition according to present invention are also based on polyamides and aminoamides based on aliphatic, cycloaliphatic, heterocyclic and aromatic amines and polyamines and/or their adducts with cycloaliphatic and aliphatic dimeric and polymeric fatty mono and di and polycarboxylic acids.

Preferred amino hardeners are selected from dicyandiamide (DICY), isophoronediamine (IPDA), diethylenetriamine (DETA), triethylenetetramine (TETA), bis (p-aminocyclohexyl) methane (PACM), ethylenediamine (EDA), tetraethylenepentamine (TEPA), polyoxypropylenediamine, polyoxypropylenetriamine, polyetheramine D230, T403, etc., diaminodiphenylmethane (DDM), diaminodiphenylsulfone (DDS, 2,4-diamino-1-methylcyclohexane, 2,6-diamino-1-methylcyclohexane, 2,4-diamino-3,5-diethyltoluene, 2,6-diamino-3,5-diethyltoluene, 3,3′,5,5′-tetramethyl-4,4′-diaminobiphenyl and 3,3′-dimethyl-4,4′-diaminodiphenyl, and also aminoplast resins.

Further, hardeners used to prepare a curable high molecular weight epoxy resin composition according to present invention are also based on polyamides and aminoamides based on polyesters, anhydrides, i. e. aliphatic, cycloaliphatic, heterocyclic and aromatic polyanhydrides, and polyacids and/or their adducts with cycloaliphatic and aliphatic and aromatic epoxides.

Preferred anhydride hardeners are selected from hexahydrophthalic anhydride, methylhexahydrophthalic anhydride, tetrahydrophthalic anhydride, methyltetrahydrophthalic anhydride, endomethylenetetrahydrophthalic anhydride, methylnadic anhydride, methylbutenyltetrahydrophthalic anhydride, hydrogenated methylnadic anhydride, trialkyltetrahydrophthalic anhydride, cyclohexanetricarboxylic anhydride, methylcyclohexenedicarboxylic anhydride, methylcyclohexanetetracarboxylic acid dianhydride, maleic anhydride, phthalic anhydride, succinic anhydride, dodecenylsuccinic anhydride, octenylsuccinic anhydride, pyromellitic anhydride, trimellitic anhydride, alkylstyrene-maleic anhydride copolymer, chlorendic anhydride, polyazelaic anhydride, benzophenone tetracarboxylic anhydride, ethylene glycol bisanhydrotrimellitate, glycerol tristrimellitate, glycerin bis (anhydrotrimellitate) monoacetate, benzophenonetetracarboxylic acid, polyadipic anhydride, polysebacic anhydride, poly (ethyloctadecanedioic acid) anhydride, poly (phenylhexadecanedioic acid) anhydride, HET anhydride, and norbornane-2,3-dicarboxylic anhydride.

Further, hardeners used to prepare a curable high molecular weight epoxy resin composition according to present invention are also based on melamine, urea and phenol formaldehyde resins, novolacs and polyphenols such as dicyclopentadiene diphenols.

Preferred hardeners are selected from phenol-formaldehyde, resorcinol-formaldehyde, catechol-formaldehyde, hydroquinine-formaldehyde, cresol-formaldehyde, chloroglucinol-formaldehyde, pyrogallol-formaldehyde, melamine-formaldehyde, urea-formaldehyde.

The curing process of resins prepared according to present invention further uses hardeners based on masked or unmasked polyisocyanates and also based on Lewis bases, such as trimethylamine, quinuclidine, pyridine, tetrahydrothiophene and/or trimethylphosphine, and Lewis acids, such as FeCl₃, AlCl₃, SbCl₅, SnCl₄, TiCl₄, BF₃, SO₂Cl₂ and/or metal triflate complexes.

In another embodiment of the present invention, a process of producing curable high molecular weight epoxy resin in enclosed, said curable high molecular weight epoxy resin is prepared by using a composition of high molecular weight epoxy resin based on a low molecular weight epoxy resin based on BPA with epoxy equivalent weight 172-500 g/mol, and oligomers, monomers and/or polymers of dicyclopentadiene diphenols and/or bisphenol For S or Z or C or polyalkyl BPF, alkyl biphenol, polyalkyl biphenol, or polyalkyl BPA and/or mixtures of above-said phenolic substances and/or aliphatic, cycloaliphatic and aromatic polyacids or their anhydrides and/or aliphatic and/or cycloaliphatic and/or aromatic polyalcohols or polyphenols and/or mixtures of above-said monomers, wherein the content of free BPA in the final high molecular weight epoxy resin is below 2 ppm, preferably below 1 ppm, and selected hardener.

### EXAMPLES

Preparation of the Resin According to Present Invention

### Example 1.

A four-necked flask equipped with a stirrer, thermometer, reflux condenser, inert gas inlet and heating nest was charged with:
262.89 g of a low molecular weight epoxy resin having an epoxy equivalent weight of 192 g/mol of epoxy groups,
137.1 g of dicyclopentadiene diphenol oligomer with equivalent weight 168 g/mol and
ethyltriphenylphosphonium bromide addition reaction catalyst in amount of 0.05%.

Stirring was started and the reaction mixture was heated under a stream of inert nitrogen to the temperature of 140° C. and reacted for 4 hours while controlling the content of epoxide groups. After completion of the reaction, the product had an epoxy equivalent of 685 g/mol of epoxy groups, a softening point of 103° C. and a viscosity of the 40% (by weight) solution in butyl glycol of 283 mPas.

An analysis of the content of free BPA in resulting epoxy resin was carried out by high-performance liquid chromatography (HPLC) using the Agilent 1260 Infinity Il liquid chromatograph having the Agilent Poroshell 120 EC-C18 2.7 μm 4.6×100 mm column which is further equipped with a photodiode array detector (PDA), which was set up to a wavelength of 227 nm (maximum absorbance of BPA). Mobile phase consisted of 60% methanol and 40% water (in the case of the sample, the resin was washed from the column using pure tetrahydrofuran (THF) for the time of 10 minutes). The flow rate of the mobile phase was 1 ml/min. Samples were prepared as solutions in THF with a concentration of ˜10 mg/ml. Mobile phase consisted of 60% methanol and THF. The concentrations of the calibration solutions were in the range of =0.1-9exp.-5 mg/ml, the dosed volume was 3 ul.

There were nine calibration solutions and each was dosed twice. A sample was prepared three times and each solution was dosed twice. The content of free BPA in prepared epoxy resin was below the detection limit, i.e. below 1 ppm.

Further, an additional analysis of the content of free BPA in prepared epoxy resin was carried out using quantitative test developed by Solvias AG “Method for the determination of Bisphenol-A in solid epoxy resins by LC/MS” (standard No. CSOP-0724_01). The content of free BPA in prepared epoxy resin was measured below 1 ppm.

### Example 2.

A four-necked flask equipped with a stirrer, thermometer, reflux condenser, inert gas inlet and heating nest was charged with
294.9 g of a low molecular weight epoxy resin having an epoxy equivalent weight of 192 g/mol epoxy groups,
105.1 g of dicyclopentadiene diphenol oligomer with equivalent weight 168 g/mol, and
ethyltriphenylphosphonium bromide addition reaction catalyst in amount of 0.05%.

Stirring was started and the reaction mixture was heated under a stream of inert nitrogen to the temperature of 140° C. and reacted for 4 hours while controlling the content of epoxide groups. After completion of the reaction, the product had an epoxy equivalent of 450 g/mol of epoxy groups, a softening point of 91° C. and a viscosity of the 40% (by weight) solution in butyl glycol of 151 mPas.

The content of free BPA was analysed by HPLC with calibration for BPA (according to Example 1) below the detection limit of 1 ppm.

### Example 3.

A four-necked flask equipped with a stirrer, thermometer, reflux condenser, inert gas inlet and heating nest was charged with
237.7 g of a low molecular weight epoxy resin having an epoxy equivalent weight of 192 g/mol epoxy groups,
162.3 g of dicyclopentadiene diphenol oligomer with equivalent weight 168 g/mol, and
ethyltriphenylphosphonium bromide addition reaction catalyst in amount of 0.1%.

Stirring was started and the reaction mixture was heated under a stream of inert nitrogen to the temperature of 180° C. and reacted for 6 hours while controlling the content of epoxide groups. After completion of the reaction, the product had an epoxy equivalent of 1482 g/mol of epoxy groups, a softening point of 128° C. and a viscosity of the 40% (by weight) solution in butyl glycol of 76 mPas.

The content of free BPA was analysed by HPLC with calibration for BPA (according to Example 1) below the detection limit of 1 ppm.

### Example 4.

A four-necked flask equipped with a stirrer, thermometer, reflux condenser, inert gas inlet and heating nest was charged with:
227 g of a low molecular weight epoxy resin having an epoxy equivalent weight of 192 g/mol epoxy groups,
173 g of dicyclopentadiene diphenol oligomer with equivalent weight 168 g/mol, and
ethyltriphenylphosphonium bromide addition reaction catalyst in amount of 0.1%.

Stirring was started and the reaction mixture was heated under a stream of inert nitrogen to the temperature of 190° C. and reacted for 6 hours while controlling the content of epoxide groups. After completion of the reaction, the product had an epoxy equivalent of 2655 g/mol of epoxy groups, a softening point of 151° C.

The content of free BPA was analysed by HPLC with calibration for BPA (according to Example 1) below the detection limit of 1 ppm.

### Example 5.

A four-necked flask equipped with a stirrer, thermometer, reflux condenser, inert gas inlet and heating nest was charged with:
227 g of a low molecular weight epoxy resin having an epoxy equivalent weight of 192 g/mol epoxy groups,
50 g of isophtalic acid, and
ethyltriphenylphosphonium bromide addition reaction catalyst in amount of 0.05%.

Stirring was started and the reaction mixture was heated under a stream of inert nitrogen to the temperature of 140° C. and reacted for 4 hours while controlling the content of epoxide groups. After completion of the reaction, the product had an epoxy equivalent of 470 g/mol of epoxy groups, a softening point of 82° C.

The content of free BPA was analysed by HPLC with calibration for BPA (according to Example 1) below the detection limit of 1 ppm.

### Example 6.

A four-necked flask equipped with a stirrer, thermometer, reflux condenser, inert gas inlet and heating nest was charged with:
227 g of a low molecular weight epoxy resin having an epoxy equivalent weight of 192 g/mol epoxy groups,
50 g of cyclohexanedicarboxylic acid, and
ethyltriphenylphosphonium bromide addition reaction catalyst in amount of 0.05%.

Stirring was started and the reaction mixture was heated under a stream of inert nitrogen to the temperature of 140° C. and reacted for 4 hours while controlling the content of epoxide groups. After completion of the reaction, the product had an epoxy equivalent of 455 g/mol of epoxy groups, a softening point of 75° C.

The content of free BPA was analysed by HPLC with calibration for BPA (according to Example 1) below the detection limit of 1 ppm.

### Example 7.

A four-necked flask equipped with a stirrer, thermometer, reflux condenser, inert gas inlet and heating nest was charged with:
227 g of a low molecular weight epoxy resin having an epoxy equivalent weight of 192 g/mol epoxy groups,
56 g of terephthalic acid,
56 g of dicyclopentadiene diphenol oligomer with equivalent weight 168 g/mol, and
ethyltriphenylphosphonium bromide addition reaction catalyst in amount of 0.05%.

Stirring was started and the reaction mixture was heated under a stream of inert nitrogen to the temperature of 180° C. and reacted for 6 hours while controlling the content of epoxide groups. After completion of the reaction, the product had an epoxy equivalent of 1967 g/mol of epoxy groups, a softening point of 135° C.

The content of free BPA was analysed by HPLC with calibration for BPA (according to Example 1) below the detection limit of 1 ppm.

### Example 8.

A four-necked flask equipped with a stirrer, thermometer, reflux condenser, inert gas inlet and heating nest was charged with:
227.0 g of a low molecular weight epoxy resin having an epoxy equivalent weight of 192 g/mol epoxy groups,
137 g of tetramethyl bisphenol F with equivalent weight 128.17 g/mol, and
ethyltriphenylphosphonium bromide addition reaction catalyst in amount of 0.05%.

Stirring was started and the reaction mixture was heated under a stream of inert nitrogen to the temperature of 200° C. and reacted for 6 hours while controlling the content of epoxide groups. After completion of the reaction, the product had an epoxy equivalent of 3264 g/mol of epoxy groups, a softening point of 155° C. and a viscosity of the 40% (by weight) solution in butyl glycol of 151 mPas.

The content of free BPA was analysed by HPLC with calibration for BPA (according to Example 1) below the detection limit of 1 ppm.

### Example 9.

A four-necked flask equipped with a stirrer, thermometer, reflux condenser, inert gas inlet and heating nest was charged with:
227.0 g of a low molecular weight epoxy resin having an epoxy equivalent weight of 192 g/mol epoxy groups,
101 g of bisphenol Z with equivalent weight 134.18 g/mol, and
ethyltriphenylphosphonium bromide addition reaction catalyst in amount of 0.05%.

Stirring was started and the reaction mixture was heated under a stream of inert nitrogen to the temperature of 140° C. and reacted for 4 hours while controlling the content of epoxide groups. After completion of the reaction, the product had an epoxy equivalent of 767 g/mol of epoxy groups, a softening point of 105° C. and a viscosity of the 40% (by weight) solution in butyl glycol of 305 mPas.

The content of free BPA was analysed by HPLC with calibration for BPA (according to Example 1) below the detection limit of 1 ppm.

### Example 10.

A four-necked flask equipped with a stirrer, thermometer, reflux condenser, inert gas inlet and heating nest was charged with:
227.0 g of a low molecular weight epoxy resin having an epoxy equivalent weight of 192 g/mol epoxy groups,
102.5 g of 4,4′-biphenol with equivalent weight 93.1 g/mol, and
ethyltriphenylphosphonium bromide addition reaction catalyst in amount of 0.05%.

Stirring was started and the reaction mixture was heated under a stream of inert nitrogen to the temperature of 200° C. and reacted for 4 hours while controlling the content of epoxide groups. After completion of the reaction, the product had an epoxy equivalent of 2030 g/mol of epoxy groups, a softening point of 145° C.

The content of free BPA was analysed by HPLC with calibration for BPA (according to Example 1) below the detection limit of 1 ppm.

### Example 11.

A four-necked flask equipped with a stirrer, thermometer, reflux condenser, inert gas inlet and heating nest was charged with:
100.0 g of a low molecular weight epoxy resin having an epoxy equivalent weight of 192 g/mol epoxy groups,
25 g of bisphenol F with equivalent weight 100.12 g/mol,
30 g of dicyclopentadiene diphenol oligomer with equivalent weight 294.55 g/mol, and
ethyltriphenylphosphonium bromide addition reaction catalyst in amount of 0.05%.

Stirring was started and the reaction mixture was heated under a stream of inert nitrogen to the temperature of 140° C. and reacted for 4 hours while controlling the content of epoxide groups. After completion of the reaction, the product had an epoxy equivalent of 806 g/mol of epoxy groups, a softening point of 101° C. and a viscosity of the 40% (by weight) solution in butyl glycol of 315 mPas.

The content of free BPA was analysed by HPLC with calibration for BPA (according to Example 1) below the detection limit of 1 ppm.

### Example 12.

A four-necked flask equipped with a stirrer, thermometer, reflux condenser, inert gas inlet and heating nest was charged with:
235.0 g of a low molecular weight epoxy resin having an epoxy equivalent weight of 192 g/mol epoxy groups,
77 g of dimethylresorcinol with equivalent weight 69.08 g/mol, and
ethyltriphenylphosphonium bromide addition reaction catalyst in amount of 0.05%.

Stirring was started and the reaction mixture was heated under a stream of inert nitrogen to the temperature of 190° C. and reacted for 4 hours while controlling the content of epoxide groups. After completion of the reaction, the product had an epoxy equivalent of 2022 g/mol of epoxy groups, a softening point of 140° C.

The content of free BPA was analysed by HPLC with calibration for BPA (according to Example 1) below the detection limit of 1 ppm.

### Example 13.

A powder coating composition based on epoxy resin according to Example 1 was prepared by using polyester hardener having carboxylic groups Crylcoat 340 with an acidity number of 75 mg KOH/g. TiO2 pigment (Kronos 2160), BlacFixe F filler with volume concentration (PVC) of 15% vol., benzoin as an anti-foaming agent and Resiflow PV-85 as a flow-promoting agent were further added.

TABLE 1
Formulation of the powder coating prepared according to Example 13

| | | |
|---|---|---|
| Crylcoat 340 (hardener) | [Parts by mass] | 100 |
| Epoxy resin prepared according to Example 1 | [Parts by mass] | 100 |
| Pigment-TiO₂ (Kronos 2160) | [Parts by mass] | 101.39 |
| Filler-BaSO₄ (Blanfixe F) | [Parts by mass] | 21.26 |
| Anti-foaming agent-Benzoin | [Parts by mass] | 1.14 |
| Flow-promoting agent-Resiflow PV-85 | [Parts by mass] | 3.27 |

Prepared composition was extruded twice, ground to a granulometry of 20-80 micrometers and electrostatically sprayed onto earthed metal plates. Metal plates were subsequently cured for 20 minutes at 180° C.

TABLE 2
Properties of the powder coating prepared according to Example 13

| Stability at 40° C. before | Degree | | 7-8 |
|---|---|---|---|
| curing (sintering) | | | |
| Properties of the powder | | | |
| coating after curing | | Method used | |
| Adhesion to the substrate | Degree | EN ISO 2409 | 0 |
| (Cross-cut test) | | | |
| Bend (Bend test) | [mm] | EN ISO 1519 | 3 |
| Impact resistance of the surface | [cm] | EN ISO 6272-1 | at least 80 |
| Impact resistance of the layer | [cm] | EN ISO 6272-1 | at least 80 |
| Erichsen (Erichsen cupping test) | [mm] | EN ISO 1520 | at least 8 |
| Gloss at 60° | [%] | ISO 2813 | at least 80 |

The content of free BPA was analysed in ground cured coating after extraction in Soxhlet extraction apparatus using tetrahydrofuran by HPLC with calibration for BPA (according to Example 1) below the detection limit.

### Example 14.

A coating composition for use as a protective coatings for metal containers based on 45% solution (by weight) of an epoxy resin prepared according to Example 4, was dissolved in the mixture of methyl isobutyl ketone and Dowanol PM and further mixed with melamine-formaldehyde resin Cymel 303 in a ratio of 70 parts of an epoxy binder and 30 parts of Cymel 303 hardener. TiO₂ pigment (Kronos 2160), BlacFixe F filler with volume concentration (PVC) of 15% vol., Byk A 530 as an anti-foaming agent and Disperbyk 163 as a dispersing additive were further added. Prepared composition was cured for 30 minutes at 140° C.

TABLE 3
Formulation of the powder coating prepared according to Example 14

| | | |
|---|---|---|
| Cymel 303 (Hardener) | [Parts by mass] | 19.3 |
| Epoxy resin prepared according to Example 4 | [Parts by mass] | 100 |
| Pigment-TiO₂ (Kronos2160) | [Parts by mass] | 24 |
| Filler-BaSO₄ (Blanfixe F) | [Parts by mass] | 24 |
| Anti-foaming agent-Byk A 530 | [Parts by mass] | 1.14 |
| Dispersing additive-Disperbyk 163 | [Parts by mass] | 5 |

TABLE 4
Properties of the powder coating according to Example 14

| Stability at laboratory temperature | Months | | 3 |
|---|---|---|---|
| (i.e. 23° C.) before curing | | | |
| Properties of the powder | | | |
| coating after curing | | Method used | |
| Dry film thickness | [μm] | EN ISO 12944-5 | 45/50 |
| Adhesion to the substrate | Degree | EN ISO 2409 | 0 |
| (Cross-cut test) | | | |
| Bend (Bend test) | [mm] | EN ISO 1519 | 3 |
| Impact resistence of the surface | [cm] | EN ISO 6272-1 | at least 60 |
| Impact resistence of the layer | [cm] | EN ISO 6272-1 | at least 60 |
| Erichsen (Erichsen cupping test) | [mm] | EN ISO 1520 | at least 8 |
| Gloss at 60° | [%] | EN ISO 2813 | at least 80 |

1. A high molecular weight epoxy resin composition comprising
(a) a low molecular weight BPA-based epoxy resin comprising bisphenol A diglycidyl ether with an epoxy equivalent of 172-500 g/mol and
(b) oligomers, monomers, and/or polymers of dicyclopentanediene diphenols,
wherein the content of free BPA in the final high molecular weight epoxy resin composition is below 2 ppm, preferably below 1 ppm.

2. The high molecular weight epoxy resin composition of claim 1, further comprising:
(a) bisphenol F, bisphenol S, bisphenol Z, bisphenol C, polyalkyl BPF, alkyl biphenol, polyalkyl biphenol, or polyalkyl BPA;
(b) mixtures of (a) and/or mixtures of (a) and oligomers, monomers, and/or polymers of dicyclopentanediene diphenols;
(c) aliphatic, cycloaliphatic, and aromatic polyacids or their anhydrides;
(d) aliphatic, cycloaliphatic, and/or aromatic polyalcohols or polyphenols; and/or
(e) mixtures of (c) and/or (d) and/or oligomers, monomers, and/or polymers of dicyclopentanediene diphenols

3. (canceled).

4. The high molecular weight epoxy resin composition of claim 1, wherein the composition is hardener cured, and wherein the free BPA content of the hardener cured high molecular weight epoxy resin composition is below 1 ppm.

5. The hardener cured high molecular weight epoxy resin composition of claim 4, wherein the hardener is selected from the group consisting of:
(a) polyetheramines; aliphatic, cycloaliphatic, heterocyclic, and aromatic polyamines, and/or their adducts with cycloaliphatic, aliphatic, and aromatic epoxides, urea derivatives, and dicyandiamide;
(b) polyesters, aliphatic anhydrides, cycloaliphatic anhydrides, heterocyclic anhydrides, and aromatic polyanhydrides, polyacids, adducts thereof with cycloaliphatic, aliphatic, and aromatic epoxides;
(c) polyamides and aminoamides based on aliphatic, cycloaliphatic, heterocyclic, and aromatic amines and polyamines and their adducts with cycloaliphatic, aliphatic dimeric, and polymeric fatty mono, di, and polycarboxylic acids;
(d) melamine, urea, and phenol formaldehyde resins, novolacs and polyphenols;
(e) masked or unmasked polyisocyanates;
(f) Lewis bases and acids; and
(g) (g) any combination thereof.

6. The hardener cured high molecular weight epoxy resin composition of claim 4, wherein the proportion of a resin is 10-97% by weight and the remaining 90-3% by weight proportion of the composition is the hardener.

7. A method for producing a high molecular weight epoxy resin composition, wherein the method comprises
mixing and reacting a low molecular weight BPA-based epoxy resin with an epoxy equivalent of 172-500 g/mol at a temperature in the range of 50-250° C. in the presence of a catalyst based on ammonium or phosphonium salts with
(a) oligomers, monomers, and/or polymers of dicyclopentanediene diphenols,
wherein the free BPA content of the resulting high molecular weight epoxy resin composition is below 2 ppm.

8. The method for producing [[a]] the high molecular weight epoxy resin composition of claim 7, wherein the catalyst based on ammonium or phosphonium salts is selected from the group consisting of ethyltriphenylphosphonium bromide, ethyltriphenylphosphonium chloride triphenylphosphine, benzyltributylammonium chloride, benzyltriethylammonium chloride, benzyltrimethylammonium chloride, tetrabutylammonium bromide, tetramethylammonium chloride, tetramethylammonium bromide, tetrabutylammonium hydrogen sulfite, trioctylmethylammonium chloride, benzyltriethyl ammonium bromide, tetraethyl ammonium chloride, trimethylamine, and halogenated phosphonium salts.

9. The method for producing the hardener cured high molecular weight epoxy resin composition of claim 6, comprising curing said resin is cured with hardeners, wherein the final free BPA content of the cured high molecular weight epoxy resin composition is below 1 ppm.

10. The method for producing the hardener cured high molecular weight epoxy resin composition of to claim 9, wherein the hardener is selected from the group consisting of:
a) polyetheramines; aliphatic, cycloaliphatic, heterocyclic, and aromatic polyamines, and/or their adducts with cycloaliphatic, aliphatic, and aromatic epoxides, urea derivatives, and dicyandiamide;
b) polyesters, aliphatic anhydrides, cycloaliphatic anhydrides, heterocyclic anhydrides, and aromatic polyanhydrides, polyacids, adducts thereof with cycloaliphatic, aliphatic, and aromatic epoxides;
c) polyamides and aminoamides based on aliphatic, cycloaliphatic, heterocyclic, and aromatic amines and polyamines and their adducts with cycloaliphatic, aliphatic dimeric, and polymeric fatty mono, di, and polycarboxylic acids;
d) melamine, urea, and phenol formaldehyde resins, novolacs, and polyphenols;
e) masked or unmasked polyisocyanates;
f) Lewis bases and acids; and
g) any combination thereof,
wherein the content of free BPA in the cured high molecular weight epoxy resin composition is below 1 ppm.

11. The high molecular weight epoxy resin composition of claim 2, wherein the composition is hardener cured, and wherein the free BPA content of the hardener cured high molecular weight epoxy resin is below 1 ppm.

12. The hardener cured high molecular weight epoxy resin composition of claim 11, wherein the hardener is selected from the group consisting of:
(a) polyetheramines; aliphatic, cycloaliphatic, heterocyclic, and aromatic polyamines, and/or their adducts with cycloaliphatic, aliphatic, and aromatic epoxides, urea derivatives, and dicyandiamide;
(b) polyesters, aliphatic anhydrides, cycloaliphatic anhydrides, heterocyclic anhydrides, and aromatic polyanhydrides, polyacids, adducts thereof with cycloaliphatic, aliphatic, and aromatic epoxides;
(c) polyamides and aminoamides based on aliphatic, cycloaliphatic, heterocyclic, and aromatic amines and polyamines and their adducts with cycloaliphatic, aliphatic dimeric, and polymeric fatty mono, di, and polycarboxylic acids;
(d) melamine, urea, and phenol formaldehyde resins, novolacs and polyphenols;
(e) masked or unmasked polyisocyanates;
(f) Lewis bases and acids; and
(g) any combination thereof.

13. The hardener cured high molecular weight epoxy resin composition of claim 11, wherein the proportion of a resin is 10-97% by weight and the remaining 90-3% by weight proportion of the composition is the hardener.

14. The hardener cured high molecular weight epoxy resin composition of claim 5, wherein the proportion of a resin is 10-97% by weight and the remaining 90-3% by weight proportion of the composition is the hardener.

15. The hardener cured high molecular weight epoxy resin composition of claim 12, wherein the proportion of a resin is 10-97% by weight and the remaining 90-3% by weight proportion of the composition is the hardener.

16. The method for producing the high molecular weight epoxy resin composition of claim 7, wherein the method further comprises
mixing and reacting low molecular weight BPA-based epoxy resin with an epoxy equivalent of 172-500 g/mol with:
(a) bisphenol F, bisphenol S, bisphenol Z, bisphenol C, polyalkyl BPF, alkyl biphenol, polyalkyl biphenol, or polyalkyl BPA;
(b) mixtures of (a) and/or mixtures of (a) and oligomers, monomers, and/or polymers of dicyclopentanediene diphenols;
(c) aliphatic, cycloaliphatic, and aromatic polyacids or their anhydrides;
(d) aliphatic, cycloaliphatic, and/or aromatic polyalcohols or polyphenols; and/or
(e) mixtures of (c) and/or (d) and/or oligomers, monomers, and/or polymers of dicyclopentanediene diphenols,
wherein the free BPA content of the resulting high molecular weight epoxy resin composition is below 2 ppm.

17. The method for producing the high molecular weight epoxy resin composition of claim 16, wherein the catalyst based on ammonium or phosphonium salts is selected from the group consisting of ethyltriphenylphosphonium bromide, ethyltriphenylphosphonium chloride triphenylphosphine, benzyltributylammonium chloride, benzyltriethylammonium chloride, benzyltrimethylammonium chloride, tetrabutylammonium bromide, tetramethylammonium chloride, tetramethylammonium bromide, tetrabutylammonium hydrogen sulfite, trioctylmethylammonium chloride, benzyltriethyl ammonium bromide, tetraethyl ammonium chloride, trimethylamine, and halogenated phosphonium salts.

18. The method for producing the hardener cured high molecular weight epoxy resin composition of claim 5, comprising curing said resin with hardeners, wherein the final free BPA content of the cured high molecular weight epoxy resin composition is below 1 ppm.

19. The method for producing the hardener cured high molecular weight epoxy resin composition of claim 12, comprising curing said resin with hardeners, wherein the final free BPA content of the cured high molecular weight epoxy resin composition is below 1 ppm.

20. The method for producing the hardener cured high molecular weight epoxy resin composition of claim 13, comprising curing said resin with hardeners, wherein the final free BPA content of the cured high molecular weight epoxy resin composition is below 1 ppm.

21. The method for producing the hardener cured high molecular weight epoxy resin composition of claim 14, comprising curing said resin with hardeners, wherein the final free BPA content of the cured high molecular weight epoxy resin composition is below 1 ppm.

22. The method for producing the hardener cured high molecular weight epoxy resin composition of claim 15, comprising curing said resin with hardeners, wherein the final free BPA content of the cured high molecular weight epoxy resin composition is below 1 ppm.
